(19) United States
(12) Patent Application Publication
(10) Pub. No.: US 2019/0064022 A1
(43) Pub. Date: Feb. 28, 2019

(54) CAPACITIVE VACUUM MEASURING CELL HAVING A MULTI-ELECTRODE

(71) Applicant: INFICON AG, Balzers (LI)

(72) Inventor: Carsten STRIETZEL, Feldkirch (AT)

(21) Appl. No.: 16/079,766

(22) PCT Filed: Feb. 25, 2016
(86) PCT No.: PCT/EP2016/053976

§ 371 Date: Aug. 24, 2018

(51) Int. Cl. G01L 9/00; G01L 21/00; G01L 1/14

(52) U.S. Cl. CPC G01L 9/0075; G01L 1/144; G01L 21/00

(57) ABSTRACT

The invention relates to a capacitive vacuum measuring cell having a first housing body (1) with a membrane (2) which is arranged at a distance therefrom so as to form a seal in the edge region (3) in such a way that a reference vacuum space (9) is formed therebetween, wherein opposite surfaces (7, 8) of the first housing body and of the membrane (2) comprise at least one electrode (G, G1, G2, . . . Gn, M1, M2, . . . Mn). A second housing body (4) is provided so as to form a seal with respect to the membrane (2) in the edge region and forms, with said membrane, a measuring vacuum space (10) in which connection means (5) are provided for connection to a process space.

The invention relates to a capacitive vacuum measuring cell according to the preamble of claim 1 and to a method for capacitive pressure measurement according to the preamble of claim 13.

The capacitive readout of sensors is a common method used to measure path lengths or distances. “Capacitive Sensors: Design and Applications” by Larry K. Baxter (Wiley-IEEE Press August 1996, ISBN 978-0-7803-5351-0) exhaustively describes the principles and readout methods. It is characteristic of the known configurations that the capacitance to be measured is compared with a fixed standard capacitance. This is the reference element for such measurement; it can be designed as a fixed capacitor or integrated into the sensor.

The application of capacitive measurements or measuring cells for pressure measurement is known for example from US 323 21 14 and US 482 36 03. A vacuum measuring cell optimized especially for the measurement of low pressures is known from EP 1 070 239 B1, which describes the basic structure of a ceramic CDG (Capacitive Diaphragm Gauges).

If low pressures of about 0.1 mbar to 10⁻⁶ mbar are to be measured, conventional membrane production methods are unsuitable for this because of the resulting stresses in the materials. On the other hand, the vacuum measuring cell described in EP 1 070 239 B1 provides a clear improvement as a result of the structure and the manufacturing method described therein, but it is also not possible with this production method to clamp the membrane completely uniformly on all sides. The highest possible uniform clamping of the membrane and the complete switching off of intrinsic voltage conditions are for measurement methods and measuring cells a prerequisite for the most accurate measurement, since the membrane should deform in an ideally complete and rotationally symmetrical manner under the influence of pressure.

Thus, it is known that especially in the vicinity of the so-called 0-point—i.e. in the state of the membrane where no pressure acts on the membrane—the deviation of the membrane from the ideal deflection equation is largest, since the membrane approaches a relaxed state here. Thus, the measurement result is corrupted.

It is the object of the present invention to avoid the disadvantages of the prior art and to provide a measuring cell with which a more precise and reliable measurement is possible.

A vacuum measuring cell, which allows a more precise and/or reliable measurement of low pressures, is disclosed in claim 1 and comprises a first housing body having a membrane spaced therefrom and arranged in a sealed manner in the edge region, whereby an interposed reference vacuum space is formed.

The present invention is suitable both for a vacuum measuring cell with ceramic membrane and/or housing and for a vacuum measuring cell with metallic membrane and/or housing, or for example cells with ceramic housing and metallic membrane, or vice versa with metallic housing and ceramic membrane.

An edge region is generally understood here as a circumferential region of the membrane, e.g. between 0 mm and about 2 to 7 mm from the outer edge of a usually circular membrane, but which at least additionally includes the sealing surfaces. The opposite surfaces of the first housing body of the membrane lying at a small distance, for example from 2 to 50 μm, each comprise at least one electrically conductive layer. According to the invention, this also means embodiments in which in particular the membrane, but alternatively also the first housing body, or the housing as a whole or partially, for example by means of inserts or as a whole, is or are electrically conductive. An example of the material of a particularly suitable electrically conductive layer is gold, which is particularly suitable because of its high conductivity and chemical resistance. As an alternative with even higher chemical resistance, platinum can be used for example. If the membrane itself or a housing body made of conductive material is selected, this may, for example, also be stainless steel, which as required may additionally be coated with a more conductive material, for example as explained above. However, the use of aluminum or transparent, conductive oxides (TCO or “Transparent Conductive Oxide”) is also conceivable.

A second housing body is sealingly provided opposite the membrane in the edge region and forms therewith a measuring vacuum space into which connection means open for connection to a process space. This can be, for example, a vacuum chamber with the medium to be measured such as, for example, inert, reactive gas or a mixture thereof, which forms the process gas. The first housing body and the second housing body are sealingly connected in this case to the intermediate membrane in the edge region against an environment of the measuring cell and, as far as possible in the context of known production processes for example, symmetrically connected. The electrically conductive layer on the housing surface or/and the membrane surface comprises at least two housing electrodes (G₁, G₂, . . . Gₙ) which are electrically insulated from one another, or membrane electrodes (M₁, M₂, . . . Mₙ), which are arranged so that they form at least two measuring capacitances (C₁, C₂, . . . Cₙ) with at least one opposite electrode (G, G₁, . . . Gₙ; M, M₁, . . . Mₙ), so that the deflection of the membrane at a plurality of locations can be detected separately capacitively, wherein the electrodes are operatively connectible to a signal processing unit. The measuring capacitances are separately measurable, i.e. the measurement and evaluation can be done simultaneously by the signal processing unit, i.e. in parallel, for example, to detect very rapid pressure fluctuations, or alternatively sequentially, in particular especially periodically sequentially. The measurement sequence can be controlled in this case, for example, by the clock signal of the signal processing unit according to the required temporal signal resolution.

The electrodes are formed in a planar manner and can be formed, depending on requirements, in different geometries, e.g. circular, rectangular, annular or sector-shaped. In order to follow the deformation of the membrane particularly well and to achieve greater distinctive character of the measured values, the electrically conductive layer can comprise at least three, four or more electrically insulated housing electrodes (G₁, G₂, . . . Gₙ) and/or electrically insulated membrane electrodes (M₁, M₂, . . . Mₙ), wherein at least three, four or more in particular separately measurable measuring capacitances (C₁, C₂, . . . Cₙ) are formed. In this case, a first electrode (G₁, M₁) formed in the middle of the housing surface and/or the membrane surface can be surrounded by at least three or more further electrodes (G₂, G₃, . . . Gₙ; M₂, M₃, . . . Mₙ) which are symmetrically arranged, for example. Alternatively, the other electrodes can also be arranged asymmetrically or arbitrarily, in which case compensation can be achieved with a larger computational effort.

A part of the further electrodes (G₂, G₃, . . . Gₙ; M₂, M₃, . . . Mₙ) can be arranged on at least one circumference to the first electrode (G₁, M₁). In this case, at least four membrane electrodes (M₁, M₂, . . . Mₙ) and/or at least four housing electrodes (G₁, G₂, . . . Gₙ) can be arranged symmetrically in at least four different circular sections of the membrane circle, e.g. in at least four different circular ring pieces of at least one circular ring.

At least one of the opposing surfaces of the individual measuring capacitances, by the measurement of which a vector associated with the respective pressure can be formed, is small in this case in relation to the dimensions known from conventional measuring cells. In this case, the surface (AG, AM) of the housing electrodes (G1, G2, . . . Gn) or/and the membrane electrodes (M1, M2, . . . Mn) can in each case be less than 5000 mm², in particular less than 200 mm². However, the area should be in this case at least 0.1 mm² for manufacturing reasons or for the reproducibility of the individual measurements.

In one embodiment, the electrical layer M thus comprises only one membrane electrode, which in this case can be equated with that of the electrical layer M, since any supply lines are not significant here. On the other hand, the membrane as a whole can form a membrane electrode M when the membrane is a metallic membrane. As a result of such an arrangement, only the surface of the first housing body which is opposite the membrane at a small distance has a plurality of electrodes, which is easier to realize from a production standpoint than to provide additional electrodes on the membrane which is very thin for vacuum measurements, which may in turn may still optionally change the deflection behavior of the membrane. In such a case, a plurality of housing electrodes are capacitively associated with an opposite, larger membrane electrode, i.e. a membrane electrode comprising at least the surfaces of the housing electrodes (G₁, G₂, . . . , Gₙ) in perpendicular projection to the surfaces. The measuring capacitances (C₁ . . . Cₙ) can in each case, or even in the case of an arrangement provided with multiple electrodes on both sides, be a very small capacitance of, for example, Cₙ≤1 nF, in particular Cₙ≤50 . . . 60 pF, in particular Cₙ≤30 pF. In addition, the measuring cell may comprise a fixed standard capacitance Cₛ, which, for example, is designed as a fixed capacitor or integrated in the sensor.

The housing electrodes (G₁, G₂, . . . Gₙ) can be connected to the signal processing unit 16 and the membrane electrode M or the membrane electrodes (M₁, M₂, . . . Mₙ) to a supply, or alternatively conversely, the membrane electrodes (M₁, M₂, . . . Mₙ) to the signal processing unit and a single housing electrode G, which in this case can be equated with the electrically conductive layer G, or the housing electrodes (G₁, G₂, . . . Gₙ) to the supply. The measuring cell can in this case comprise the converter associated with the respective measuring capacitances (C₁, C₂, . . . Cₙ), in particular comprise the CDC (CDC stands for “capacitivity to digital converter”), which can operatively be connected to the signal processing unit. Alternatively, the converters can also be part of the signal processing unit.

To design the vacuum cell as compact as possible and to enable its installation ready for use without further measures, a signal processing unit can be integrated into the measuring cell, which includes an arithmetic unit with at least one memory and an output unit for outputting the calculated pressure value. In this case, the converter and, if necessary, an input unit, e.g. for entering external parameters such as ambient temperature and ambient pressure, and/or a standard capacitance Cₛ can be installed in the signal processing unit. Reference values can be stored in the memory of the signal processing unit in order to compare a measured actual value therewith.

Furthermore, an algorithm, in particular a best-fit algorithm for comparing the reference values with the measured actual values, can also be stored in the memory. This algorithm can also be supplied in a known manner from the outside, for example, via an external controller of the system control or be provided in a permanently wired manner in the microprocessor of the calculator.

The invention is also realized in a method for capacitive pressure measurement. For the method, a vacuum measuring cell is analogously used with a first housing body with a membrane which is spaced therefrom and sealingly arranged in the edge region, wherein between the membrane and the first housing body, a reference vacuum space is formed and the closely spaced opposite surfaces of the first housing body and the membrane are coated with an electrically conductive layer or are even fully or partially electrically conductive. In addition, the vacuum measuring cell comprises a second housing body which is likewise sealingly provided in the spatial area opposite the membrane, in order to form therewith a measuring vacuum space, into which connecting means open for connection to the medium to be measured. First and second housing body with the interposed membrane is thus sealingly connected, so that on the one hand reference and measuring vacuum space are separated from each other and on the other hand the seal to the outside is provided. This can be done in a known manner by elastic seals and/or in particular for high vacuum measurement by glass solders. For the method, capacitance measurements are thus carried out simultaneously in parallel or alternatively in temporal sequence on at least two, but better on at least three, in particular on four or more measuring capacitances (C₁, C₂, . . . Cₙ), which are each formed between housing electrode or housing electrodes (G, G₁, G₂, . . . Gₙ) and membrane electrode or membrane electrodes (M, M₁, M₂, . . . Mₙ). In this way, it is individually possible to compensate for intrinsic biases and/or manufacturing tolerances in the clamping symmetry of the respective membrane, since thus a reference vector (C_{R1}, C_{R2}, . . . C_{Rn}) can be generated for each pressure, e.g. within the scope of calibration of the measuring cell, for comparison with later measurements in practice. This can be realized particularly easily with measuring capacitances in which measurement is carried out between a plurality of housing electrodes (G₁, G₂, . . . Gₙ) and a large membrane electrode (M) comprising the surfaces of the individual housing electrodes. The conversion of the capacitance measurements takes place by means of converters, wherein CDC converters are particularly suitable since in this case the output values of the converters are already present in digitized form. For evaluation, measured values, for example in a signal processing unit connected to the measuring cell or integrated into the measuring cell, can be forwarded to the arithmetic unit of the unit and compared by means of an algorithm with the reference values stored in the memory, in order to calculate the output value therefrom which can be passed on, for example, via an output unit. For the comparison, a best-fit algorithm can be used.

In the following the invention will be explained with reference to figures and individual embodiments. It should be noted in this case that all features, albeit only mentioned in connection with individual embodiments or the description of individual figures, can be basically combined with other features or embodiments of the invention, unless from the general knowledge of the person skilled in the art a contradiction or incompatibility of the combination of such features results immediately. This also applies to all features and embodiments mentioned in the general part of the description, whereby a combination of such features is disclosed.

The drawings show as follows:

FIG. 1 shows a measuring cell of the prior art;

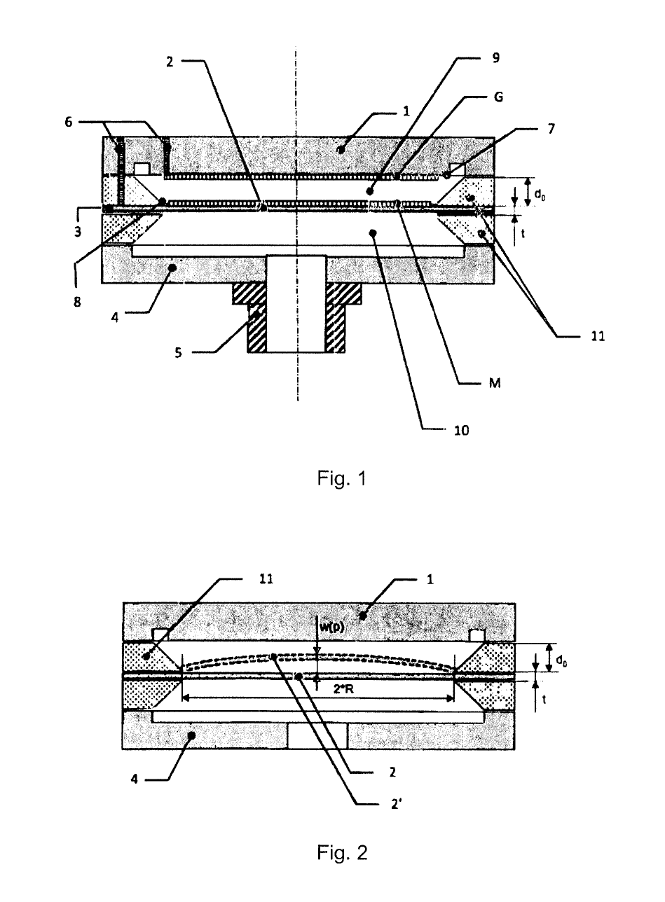

FIG. 2 shows the operation of a vacuum measuring cell;

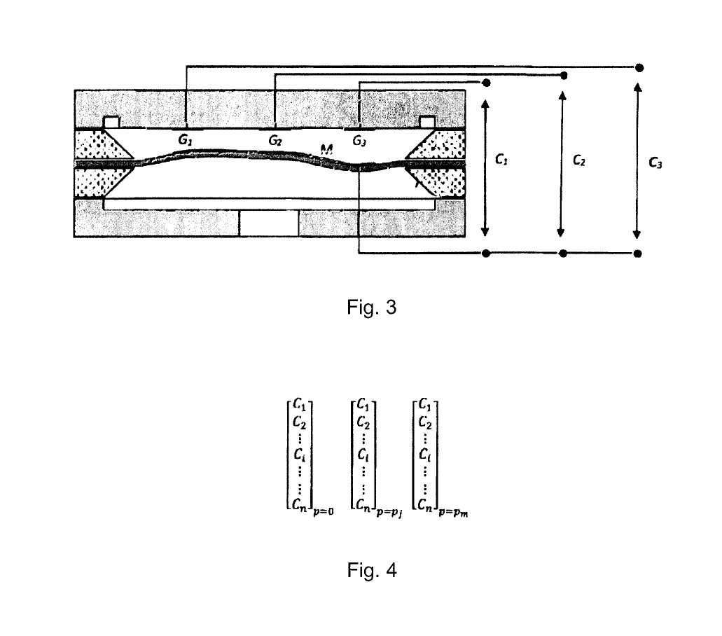

FIG. 3 shows an embodiment of a vacuum measuring cell according to the invention;

FIG. 4 shows a numerical representation of a vector field formed from individual measured values;

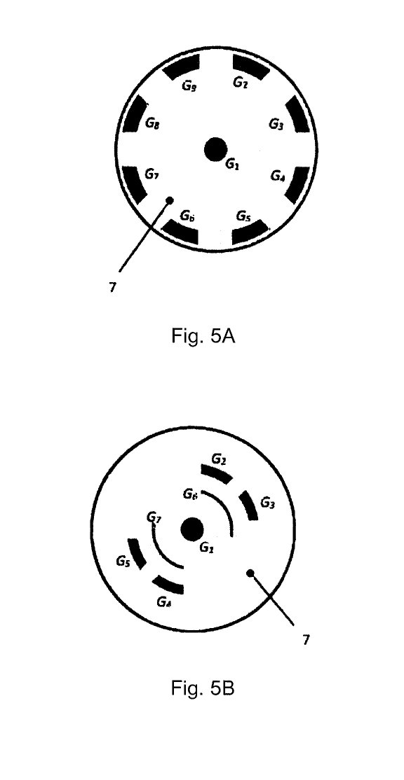

FIGS. 5a and 5b show electrode arrangements according to the invention; and

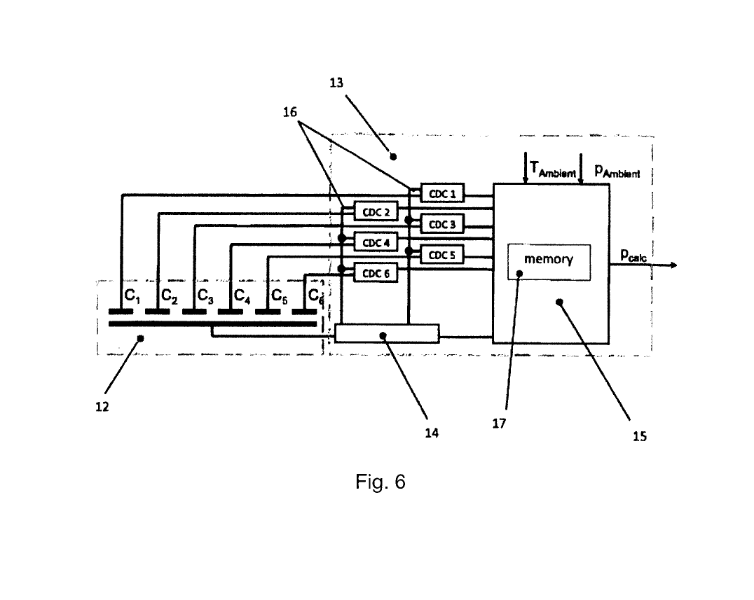

FIG. 6 shows a circuit diagram of a vacuum measuring cell according to the invention.

The measuring cell of the prior art shown in FIG. 1 is shown in cross-section and has, at least concerning the adjacent surfaces 8, 9, a substantially rotationally symmetrical structure. In the present case, the first housing is made of an insulating material, for example a ceramic plate of aluminum oxide, which is sealingly connected, at a small distance from the ceramic membrane, to said membrane in the edge area and thereby forms a reference vacuum space 9. The distance between the two surfaces is usually set when mounting on the sealing material 11, which lies between the membrane edge 3 and the edge of the housing. In this way, a largely flat housing plate 1 can be used. In the same way, a measuring vacuum chamber 10 is formed in a second housing 4 on the opposite side of the membrane, which is connectable to a process space via a connecting piece 5 through an opening in the housing 4. The seal 3 on both sides of the membrane 2 may be formed, for example, from glass solder, which is easy to handle and can be applied, for example, by screen printing. In a typical measuring cell with an outside diameter of 38 mm and a free membrane inside diameter of 30 mm, the distance d₀ between the capacitively effective surfaces is about 2 μm to 50 μm, preferably 12 μm to 35 μm. Here, for example, the first housing 1 is, for example, about 5 mm thick, the second housing 4 is, for example, about 3 to 6 mm, preferably 5 mm, thick. The second housing 4 may in this case be provided with a recess with a depth of about 0.5 mm in the inner region, as shown in FIG. 1, in order to increase the measuring vacuum chamber 10. Since in the present case both the housing 1 and the membrane 2 are made of an insulating ceramic, the housing 1 is coated on the reference vacuum side with a conductive layer which forms the housing electrode G and the membrane accordingly on the reference vacuum side with an electrically conductive layer which forms the membrane electrode M. The two layers are not electrically connected to each other. They can be painted, printed or sprayed, for example, or be applied with a vacuum method particularly suitable for the precise production of thin layers, e.g. vapor-depositing or sputtering. Furthermore, vacuum-tight, electrically conductive bushings 6 for connection to corresponding measuring means or measuring value converters such as CDG converters are provided for each electrode. In addition, getters (also not shown here) can be provided in order to maintain a long-term stable reference vacuum in the space 9. With regard to the advantageous embodiment and possible thinning of the electrode layers or the design of getters, reference is made to paragraph [0028] up to and including paragraph [0030] of EP 1 070 239 B1, which are hereby declared an integral part of the present description.

For pressure measurements on media which are less critical, for example, with respect to their corrosive properties, it is possible, as is known, to also use a metallic membrane, which can form the membrane electrode as a whole due to its electrically conductive properties. If, instead of a ceramic material, a metal is also used for the first housing body 1, the housing electrode G and the electrically conductive bushings 6 must be formed in an insulated manner relative to the housing 1.

The principal mode of operation of such a vacuum measuring cell is shown in FIG. 2, which shows a membrane in rest position 2 and a pressurized membrane 2′. The membrane 2, 2′ with the thickness t is thereby deflected into the reference vacuum space 9 with the depth d₀ by the amount w(p) as a function of the pressure and the clamping radius 2*R of the membrane 2, 2′. Accordingly, a deflection takes place in the opposite direction when a vacuum is applied via the connection means 5.

Analogous to the vacuum measuring cells shown in FIGS. 1 and 2, a vacuum measuring cell according to the invention is shown in FIG. 3, which can be designed with respect to the choice of materials and geometry, with the exception of the electrode geometry and wiring, according to the examples of the prior art. In contrast to the measuring cell shown in FIG. 1, in the embodiment according to the invention three housing electrodes are provided here, which are arranged opposite a single membrane electrode. As a result, characteristic capacitance values (Cⱼ₁, Cⱼ₂, Cⱼ₃) can be assigned to each specific pressure value pⱼ for this measuring cell.

According to the invention, on each of the opposite surfaces 7, 8 of the housing 1 or the membrane 2, but in particular for the reasons mentioned above, a multi-electrode arrangement, as shown in FIGS. 5A and 5B, can be formed on the housing surface 7. The corresponding electrodes are, as shown, arranged symmetrically, for example, about a central housing electrode G₁. As a result, for example, for a number m of measured pressure values p₁, a vector containing n capacitance measurements corresponding to the number n of electrodes can be created and the sum m of the respectively obtained vectors can be represented as a vector field, as shown in FIG. 4. Depending on the desired accuracy of the measurement resolution, any number of reference measurement points defined by a respective n-dimensional vector can be recorded and saved for comparison purposes. This can also be done asymmetrically, for example in such a way that finer pressure steps Δp than in a less relevant pressure range are measured in a target pressure range and stored as reference vectors.

FIG. 6 shows the circuit diagram of a pressure sensor 12 according to the invention, which is constructed in this case from a membrane electrode and six housing electrodes, or vice versa, i.e. from a housing electrode and six membrane electrodes, and which is connected to a signal processing unit 13. Although the signal processing unit 13 may be provided externally, e.g. in a vacuum system controller, it is easily possible and advantageous, due to the current progressive miniaturization, even with vacuum measuring cells of small design, to integrate the signal processing unit in the measuring cell, since thus the sensor-related data are always connected to the right sensor and any possible confusion caused by incorrectly placed cables are excluded. The signal processing unit includes a supply 14 as a signal generator for the sensor and here also a voltage source for the unit, which can be battery-powered and/or connected to the mains. The central component is the arithmetic unit 15, which comprises a memory 17 with the saved reference values or has access to this memory. Furthermore, an algorithm is stored there or at another memory location, alternatively also hardwired or predetermined by the structure of the semiconductor, with the aid of which the arithmetic unit 15 compares the capacitance values or vectors which were sent via the converter 16 to the arithmetic unit or were already digitized with the reference vectors stored in the memory 17. This can be done for example with a best-fit method. In addition, the values for ambient temperature T_{amb} or ambient pressure P_{amb}, which were supplied in this case only by way of example via separate inputs, and the measurement of a standard capacitance Cₛ (not shown here) can be used as required for correcting and further improving the accuracy of the measured values.

With a construction designed as described above and a method for operating a measuring cell as detailed above, the measuring pressure can be determined by comparing reference values of the capacitances measured individually for different pressures, e.g. as reference value vectors (C_{R22}, C_{R22}, . . . C_{R1n}), (C_{R21}, C_{R22}, . . . C_{R2n}), . . . (C_{Rm1}, C_{Rm2}, . . . C_{Rmn}), with the capacitance measured values (C₁, C₂, . . . Cₙ) measured at a measuring pressure, for example as a capacitance vector, as a result of which it is managed to individually consider and compensate individual differences, e.g. due to manufacturing tolerances, in the geometry of different measuring cells, in particular with respect to the geometry and pretension of the membrane. As a result, not only are more precise and reliable measurements possible, but also a particularly fine resolution Δp of the pressure to be measured can also be achieved for desired measuring ranges, for example particularly process-relevant ones, by depositing a greater number of reference values. Thus, the present invention offers the possibility of optimally designing vacuum measuring cells for very different pressures.

1. Capacitive vacuum measuring cell having a first housing body (1) with a membrane (2) which is arranged at a distance therefrom so as to form a seal in the edge region (3) in such a way that a reference vacuum space (9) is formed therebetween, wherein opposite surfaces (7, 8) of the first housing body and of the membrane (2) comprise at least one electrode (G, G₁, G₂, . . . Gₙ, M₁, M₂, . . . Mₙ), wherein a second housing body (4) is provided so as to form a seal with respect to the membrane (2) in the edge region and forms, with said membrane, a measuring vacuum space (10) in which connection means (5) are provided for connection to a process space, characterized in that the electrodes (G, G₁, G₂, . . . Gₙ; M₁, M₂, . . . Mₙ) on the housing surface (7) and/or the membrane surface (8) comprise at least two, mutually electrically insulated housing electrodes (G₁, G₂, . . . Gₙ) or/and membrane electrodes (M₁, M₂, . . . Mₙ), which are arranged so that they form with at least one opposite electrode (G, G₁, G₂, . . . Gₙ; M₁, M₂, . . . Mₙ) at least two measuring capacitances (C₁, C₂, . . . Cₙ), so that a deflection of the membrane can be detected capacitively at a plurality of locations, wherein the housing electrode (G) or the housing electrodes (G₁, G₂, . . . Gₙ) and the membrane electrode (M) or the membrane electrodes (M₁, M₂, . . . Mₙ) can be operatively connected to a signal processing unit.

2. Measuring cell according to claim 1, characterized in that the electrodes (G, G₁, G₂, . . . Gₙ; M₁, M₂, . . . Mₙ) comprise at least three or more electrically insulated housing electrodes (G₁, G₂, . . . Gₙ) or/and mutually electrically insulated membrane electrodes (M₁, M₂, . . . Mₙ), and at least three or more measuring capacitances (C₁, C₂, . . . Cₙ) are formed.

3. Measuring cell according to claim 1, characterized in that a first electrode (G₁, M₁) formed in the middle of the housing surface (7) and/or the membrane surface (8) is surrounded by at least four further electrodes (G₂, G₃, . . . Gₙ; M₂, M₃, . . . Mₙ) arranged symmetrically thereto.

4. Measuring cell according to claim 1, characterized in that at least four membrane electrodes (M₁, M₂, . . . Mₙ) and/or four housing electrodes (G₁, G₂, . . . Gₙ) are symmetrically arranged in at least four different circular sections.

5. Measuring cell according to claim 1, characterized in that the surface (AG, AM) of the housing electrodes (G1, G2, . . . Gn) or/and membrane electrodes (M1, M2, . . . Mn) is less in each case than 5000 mm², in particular less than 200 mm², but in this case at least 0.1 mm².

6. Measuring cell according to claim 1, characterized in that the membrane (2) comprises only one membrane electrode (M) or it is the membrane electrode.

7. Measuring cell according to claim 1, characterized in that the measuring capacitances (C₁ . . . Cₙ) each have a capacitance of Cₙ≤100 pF, preferably Cₙ≤50 . . . 60 pF, preferably Cₙ≤30 pF.

8. Measuring cell according to claim 1, characterized in that the housing electrodes (G₁, G₂, . . . Gₙ) are connected to the signal processing unit (16) and the membrane electrode (M) or the membrane electrodes (M₁, M₂, . . . Mₙ) to a supply (14), or vice versa the membrane electrodes (M₁, M₂, . . . Mₙ) to the signal processing unit (16) and the housing electrode (G) or the housing electrodes (G₁, G₂, . . . Gₙ) to a supply (14).

9. Measuring cell according to claim 1, characterized in that the measuring cell comprises the converter associated with the respective measuring capacitances (C₁, C₂, . . . Cₙ), which can be operatively connected to the signal processing unit.

10. Measuring cell according to claim 1, characterized in that the measuring cell is operatively connected to an integrated signal processing unit (13) which comprises an arithmetic unit (13), at least one memory (15) and an output unit.

11. Measuring cell according to claim 10, characterized in that reference values for comparing a measured actual value with the reference values are stored in the memory (15).

12. A method for capacitive pressure measurement with a vacuum measuring cell having a first housing body (1) with a membrane (2) which is arranged at a distance therefrom so as to form a seal in the edge region (3) in such a way that a reference vacuum space (9) is formed therebetween, wherein opposite surfaces of the first housing body (1) and of the membrane (3) are coated with an electrically conductive layer which is formed as an electrode (G, G₁, G₂, . . . Gₙ, M₁, M₂, . . . Mₙ), and a second housing body (4) is provided so as to form a seal with respect to the membrane (2) in the edge region in order to form, with said membrane, a measuring vacuum space (10) with connection means (5) for connection to a process space, characterized in that capacitance measurements are carried out on at least two, but in particular at least three measuring capacitances (C₁, C₂, . . . Cₙ), which are each formed between the housing electrode (G) or housing electrodes (G₁, G₂, . . . Gₙ) and membrane electrode (M) or membrane electrodes (M₁, M₂, M₃ . . . Mₙ), in such a way that the measurement results of the individual measuring capacitances (C₁, C₂, . . . Cₙ) can be read out individually for each measured pressure pₘ.

13. Method according to claim 12, characterized in that capacitance measurements are carried out between at least three housing electrodes (G₁, G₂, . . . Gₙ) and a membrane electrode (M).

14. Method according to claim 12, characterized in that the measured values are forwarded to an arithmetic unit (15) with at least one memory and compared by means of an algorithm with reference values stored in the memory to calculate and provide the output value therefrom.
